(19) United States
(12) Patent Application Publication
(10) Pub. No.: US 2009/0075631 A1
(43) Pub. Date: Mar. 19, 2009

(54) MISSED CALL NOTIFICATION AND MANAGEMENT INTERFACE THAT ASSOCIATES AND DISPLAYS IMAGES WITH MISSED CALLS

(75) Inventors: RUTHIE D. LYLE, DURHAM, NC (US); ULYSSES LAMONT CANNON, DURHAM, NC (US)

Correspondence Address: PATENTS ON DEMAND, P.A. IBM-RSW, 4581 WESTON ROAD, SUITE 345, WESTON, FL, 33331, US

(73) Assignee: INTERNATIONAL BUSINESS MACHINES CORPORATION, ARMONK, NY (US)

(21) Appl. No.: 11/857,953

(22) Filed: Sep. 19, 2007

(51) Int. Cl. H04Q 7/22; H04M 1/02

(52) U.S. Cl. 455/412.2; 455/566

(57) ABSTRACT

The present invention discloses a solution where images are associated with missed calls and are presented within a missed called interface. The images can include images contained within a mobile device data store that is associated with the missed call number, such as images that often appear in a display of a mobile phone when a call attempt is made. The images can also include ones that are conveyed by the caller to the called device. A set of configurable interlace options can exist that permits a mobile phone user to establish how a missed call interface should behave when a locally stored image and a caller-provided image both exist and are associated with a missed call. In one implementation, the interface can be associated with voice mail messages, so that images are also associated and presented with received voice mail entries.

### BACKGROUND

1. Field of the Invention

The present invention relates to telecommunication interfaces, and more particularly, to missed call notification and management interface that associates and displays images with missed calls.

2. Description of the Related Art

Today's mobile phones have become more powerful and now include more functionality than ever before. Some of this functionality incorporates the capability of handling media-rich content. Although such capabilities exist, very few applications take advantage of such functionality. One interface which has remained relatively unchanged on mobile phones is the missed call interface. Previous incarnations of missed call handling have opted to display caller name and/or calling number. While this format is useable, it fails to take advantage of media rich capabilities of many phones.

Another common issue with current representations of missed call logs is the inability for users to quickly glance at a set of missed calls and to assess a call return urgency. Historically, preference has been given to calls but not callers when representing missed calls. Additionally, many call logs present a series of missed calls as separate entries, even though the missed calls can be all from one caller. This can result in a missed call log with many entries for a single caller and thus overshadowing other callers. With large number of missed calls from many callers, a user can have difficulty in gaining a true representation of missed calls. It would be advantageous to users if a missed call interface presented missed call information in an easy to understand format which can allow quick assessment of missed calls.

### SUMMARY OF THE INVENTION

The present invention discloses a solution where images are associated with missed calls and are presented within a missed called interface. The images can include images contained within a mobile device data store that is associated with the missed call number, such as images that often appear in a display of a mobile phone when a call attempt is made. The images can also include ones that are conveyed by the caller to the called device. A set of configurable interlace options can exist that permits a mobile phone user to establish how a missed call interface should behave when a locally stored image and a caller-provided image both exist and are associated with a missed call. In one implementation, the interface can be associated with voice mail messages, so that images are also associated and presented with received voice mail entries.

The present invention can be implemented in accordance with numerous aspects consistent with the material presented herein. For example, one aspect of the present invention can include a method for presenting missed telecommunication calls within a telephony device. The method can log a set of missed communication attempts directed to a telephony device. An image that is associated with each of the missed communication attempts can be determined. Interface items representing said set of missed communication attempts can be visually displayed along with the determined associated images. The associated images can include a picture of the caller.

Another aspect of the present invention can include a mobile phone including a telephony interface, a display, and a missed call interface. The telephony interface can be used to conduct mobile telephony communications. The display can be configured to visually interact with the mobile phone. The missed call interface can present a set of missed call images in the display. Each missed call image can be associated with at least one missed call and each missed call image can represent a caller. For example, a user can select a picture of a caller (e.g., missed call image) within the missed call interface and be presented with information concerning the associated missed call.

Still another aspect of the present invention can include a missed call interface of a mobile telephony device. The missed call interface can visually display a set of missed calls. Each missed call can be represented by an image representing a caller whose call was missed. In one configuration, at least a portion of the presented images can be retrieved from a local data store of the mobile telephony device. The local data store can contain a set of contact entries, at least a portion of which associate a phone number with an image stored within the data store. The mobile telephony device can use the contact entries to find an image to be displayed within the missed call interlace based upon a phone number of the missed call.

It should be noted that various aspects of the invention can be implemented as a program for controlling computing equipment to implement the functions described herein, or as a program for enabling computing equipment to perform processes corresponding to the steps disclosed herein. This program may be provided by storing the program in a magnetic disk, an optical disk, a semiconductor memory, or any other recording medium. The program can also be provided as a digitally encoded signal conveyed via a carrier wave. The described program can be a single program or can be implemented as multiple subprograms, each of which interact within a single computing device or interact in a distributed fashion across a network space.

### BRIEF DESCRIPTION OF THE DRAWINGS

There are shown in the drawings, embodiments which are presently preferred, it being understood, however, that the invention is not limited to the precise arrangements and instrumentalities shown.

FIG. 1 is a schematic diagram illustrating a system for missed call notification and management via image based graphical user interface in accordance with the embodiment of inventive arrangements disclosed herein.

FIG. 2 is a schematic diagram illustrating a graphical user interface (GUI) for missed call notification and management that includes caller images for missed calls in accordance with the embodiment of inventive arrangements disclosed herein.

FIG. 3 is a flowchart illustrating a method for missed call notification and management where images relating to the callers are presented next to missed calls in accordance with the embodiment of inventive arrangements disclosed herein.

### DETAILED DESCRIPTION OF TOE INVENTION

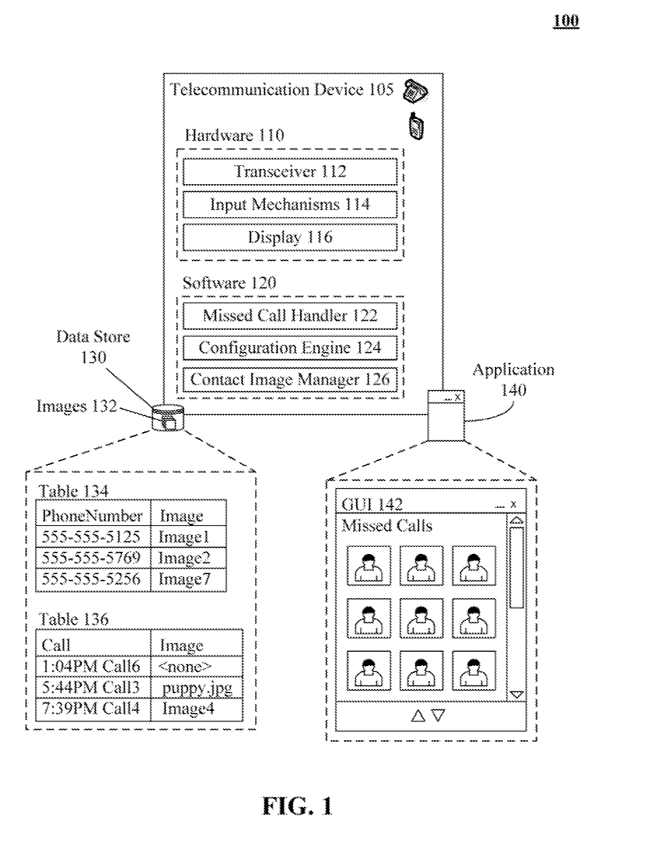

FIG. 1 is a schematic diagram illustrating a system 100 for missed call notification and management via image based graphical user interface in accordance with the embodiment of inventive arrangements disclosed herein. In system 100, a telecommunications device 105 can record missed calls and can include a graphical user interface (GUI) 142 for a user to review and manage missed calls. Review and management can be facilitated by hardware 110 and software 120. Incoming missed calls and associated information can be logged by a missed call handler 122. Input mechanisms 114 and display 116 can be utilized to present a user with missed call and missed call information. An image of a caller of the missed call can be presented for each missed call entry. Caller specific images need not be actual images of the caller, but can be any image, graphic, or video associated with or provided by the caller.

As shown, application 140 can provide a graphical user interface 142, which presents missed calls using a set of display able images, each associated with a missed call. The images of interface 142 can be presented as a slideshow, as a set of selectable thumbnail images, and in other configurable manners. Configuration options for application 140 can be handled by configuration engine 124.

A data store 130 accessible by device 105 can interact with a contact image manager 126 to determine which images 132 are to be associated with which missed calls. One set of image associations can be images that a user of device 105 associated with a set of numbers, as shown by table 134. In one embodiment, the table 134 can also be used to determine which picture or image 132 to show when the device 105 rings, assuming the device 105 shows a caller image when the phone 105 rings.

In addition to user stored images 132, other images 132 can be provided by callers. Table 136 associates specific missed calls with images, which includes images sent from callers along with missed call attempts. Although the images 132 are shown as being stored locally in data store 130, images 132 can also be from remotely located sources, such as URL addressable ones.

The telecommunication device 105 can be any device capable of sending and receiving telephone calls. Transceiver 112, which can be a wireless transceiver, can be used for receiving and sending data during a communication session. Device 105 can optionally be a multi-purpose device able to handle other types of communications, such as text messaging, email messaging, Web browsing, and the like. The device 105 can be a mobile communication device, a line based device, or a wireless device connected to a line based receiver unit. The device 105 can include customer premise equipment (CPE) and computers having telephony capabilities, such as through Voice Over Internet Protocol (VOIP) or softphone software. Although shown as a single device 105, the telecommunication device 105 can be implemented as a series of communicatively linked components that perform the functions attributed to device 105. For example, the display 116 of device 105 can a television or a computer monitor connected to a phone that otherwise lacks a display.

Data store 130 can be physically implemented within any type of hardware including, but not limited to, a magnetic disk, an optical disk, a semiconductor memory, a digitally encoded plastic memory, a holographic memory, or any other recording medium. A data store 130 can be stand-alone storage unit as well as a storage unit formed from a plurality of physical devices, which may be remotely located from one another. Additionally, information can be stored within a data store 130 in a variety of manners. For example, information, such as table 134 and 136, can be stored within a database structure or can be stored within one or more files of a file storage system, where each file may or may not be indexed for information searching purposes.

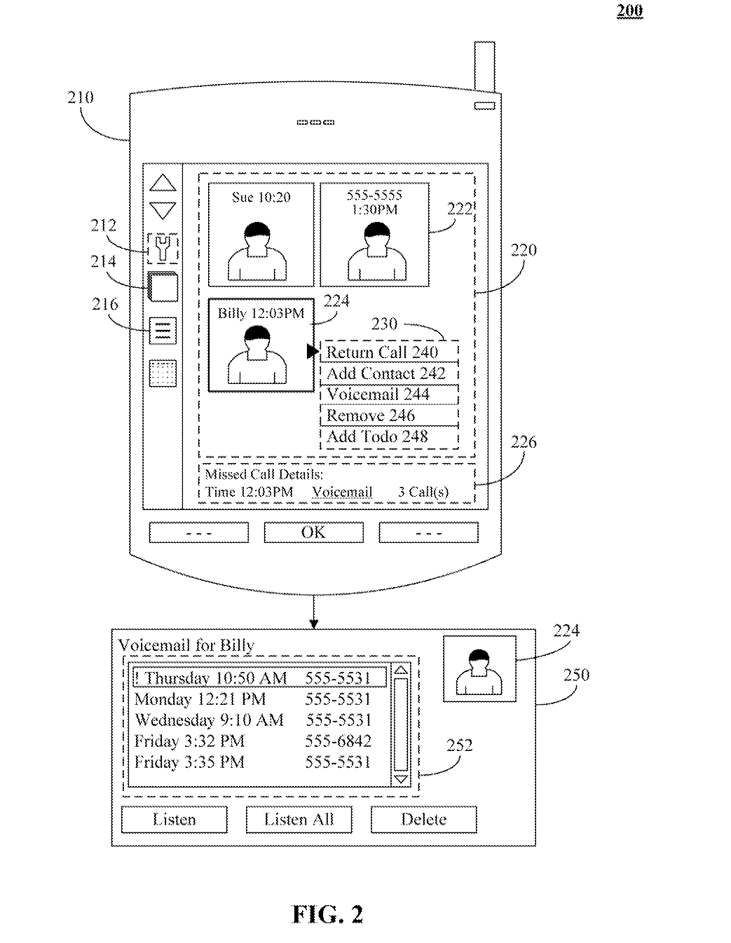

FIG. 2 is a schematic diagram illustrating a graphical user interface (GUI) 200 for missed call notification and management that includes caller images for missed calls in accordance with the embodiment of inventive arrangements disclosed herein. GUI 200 can be one implementation of GUI 142 of system 100.

GUI 200 can be used to present and manage missed calls in a telecommunications device 210. GUI section 220 can present a series of missed calls using a set of images to represent the calls. For example, image 224 for a missed call can include a photograph of the caller. This image 224 can be established by an owner of device 210, such as by associating locally stored images with phone numbers as is currently done by many mobile phones to cause an image of a caller to be presented when a phone is ringing. The image 224 can also be an image received from the caller during the call attempt that resulted in the missed call. In one embodiment, image 224 can include animated images, video segments, images captured from an embedded camera of device 210, and the like.

When an image 224 is found, the section 220 may not display a phone number of the missed call since an image 224 is sufficient to identify a caller. The image 224 can include some missed call information, such as a name of the caller, a time of call, a calling number, and the like. Additionally, a detail section 226 can present missed call details for an image 224 of section 220 that has focus. When no image exists for a missed call, a default image 222 can be presented along with a phone number of the missed call. Multiple missed calls can be associated with a single missed call GUI 220 item 222, 224. That is, a single image 224 can represent three missed call attempts from a person named Billy.

In one implementation, a context menu 230 can be presented next to a missed call element (224) that has focus. The context menu 230 can include numerous actions 240-248 that can be performed for the missed call having focus 224. For example, a return call action 240 can allow a user to call back the caller. An add contact action 242 can permit a caller to add an entry related to the caller of the missed call to a contact management application. A voicemail action 244 can retrieve a message left by the caller. A remove action 246 can remove an entry from a missed call log. An add to ToDo action 248 can allow a user to add an entry to a task management application that indicates a callback is needed.

Configuration elements 212-216 can be used to modify the presentation and behavior of the missed message interface, including behavior of section 220 and 226. Configuration element 212 can allow a user to modify image size and quantity, to modify appearance attributes (e.g., background color, animations, highlighting effects, etc.), to modify displayed attributes (e.g., name, time of call, missed number, number of missed attempts, etc.), to configure context menu 230 items, and the like. Element 214 can enable/disable a slideshow of missed calls and can customize slideshow properties. Slideshow properties can include image presentation duration, transitions between images, a number of images simultaneously presented during the slideshow, and the like. Element 216 can configure missed call options, such as an order in which missed calls are presented, a grouping option for missed calls from a common caller, and the like. Ordering options can include, but are not limited to, chronological order, ordered by frequency, known contacts with missed calls, and the like.

The image associations used for the missed calls can also be used within a voicemail interface, as shown by GUI 250. GUI 250 shows a voicemail listing of left message with in selectable list 252 box. An image 224 associated with the selected caller/calling number can be presented for the item of list 252 that has focus. Section 252 can be utilized to review voicemail details such as call date, call time, calling number and the like. Indication of urgent voicemail messages can be accomplished through special symbols, coloration, and the like. For example, an exclamation mark next to a voicemail entry can indicate an urgent voicemail has been left by caller 224.

It should be appreciated that the specific GUI arrangements shown in diagram 200 are for illustrative purposes only and that the invention is not to be limited in this regard. For example, a series of voice commands implementing features of the context menu 230 can be used in one contemplated interface embodiment. In another example, voice-mail entries can be presented within an image specific slideshow. In still another example, section 220 can be implemented in a manner similar to that shown in GUI 250, where a list of missed calls can be linked to an image box that displays an image of the list item that has focus. Derivatives to the interlace elements are contemplated, so long as an association is maintained between a caller related image and a missed call entry.

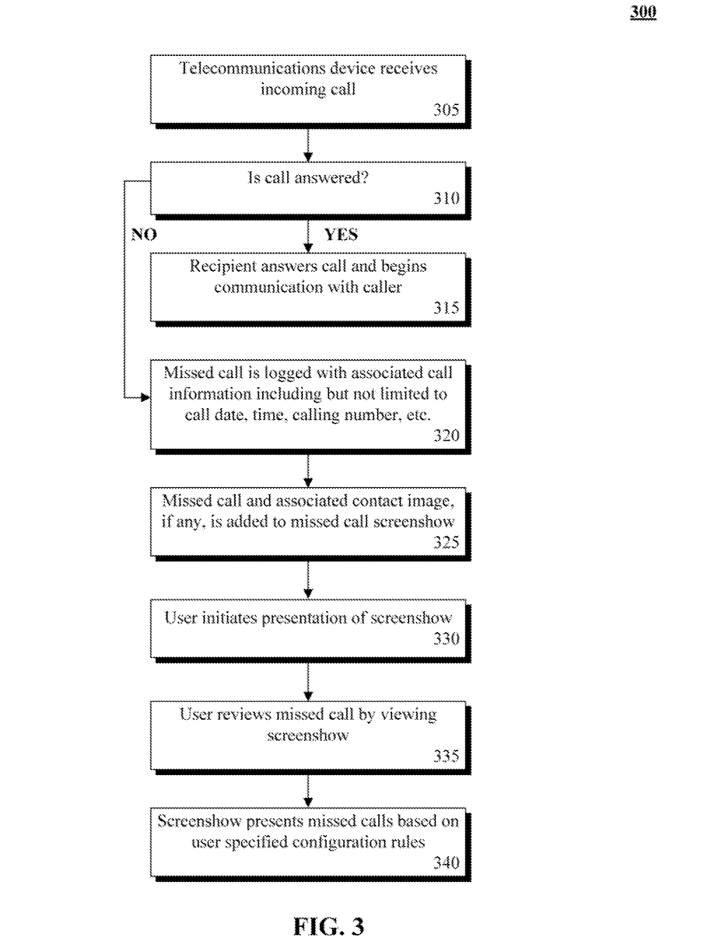

FIG. 3 is a flowchart illustrating a method 300 for missed call notification and management where images relating to the callers are presented next to missed calls in accordance with the embodiment of inventive arrangements disclosed herein. Method 300 can be performed in the context of system 100 or in the context of other missed call interface of a telephony device.

Method 300 can begin in step 305, where a user can receive an incoming call on a telecommunications device. In step 310, if the call is answered the method can end in step 315, else the method can continue to step 320. In step 315 the recipient can answer the call and can establish a communication session with the caller.

In step 320, the missed call is logged with the associated information, including but not limited to, call date, time of the call, calling number, and the like. Optionally, a caller can send an image to be associated with the missed call when making the call attempt, in which case the sent image can be logged along with other missed call information. When no image is sent by the caller, the device can query a local data store to discover any locally stored image associated with the calling number. In step 325, the missed call and associated contact image (e.g., sent image or locally stored image), if any, can be added to a missed call slideshow. The user can initiate the presentation of slideshow, as shown in step 330. Presentation of slideshow can be triggered by any number of events, including a manual user selection or a detected change of state of the telephony device. A manual selection can include a voice command, a GUI selection, a button selection, and the like. The change of state can be any detectable event, such as an opening of a clam shell phone or a power on event. In step 335, the user can review missed calls by viewing the slideshow. In step 340, the slideshow can present missed calls in accordance with a set of user specified configuration rules.

Although method 300 details use of a slideshow, which is generally a time delayed presentation of a set of image, other presentation mechanisms where caller images are associated with missed calls are contemplated. For example, a series of thumbnail images can be presented within an interface, as shown by GUI 142. Additionally, a presentation manner for the missed calls can be changed by user configurable options.

The present invention may be realized in hardware, software or a combination of hardware and software. The present invention may be realized in a centralized fashion in one computer system or in a distributed fashion where different elements are spread across several interconnected computer systems. Any kind of computer system or other apparatus adapted for a carrying out methods described herein is suited. A typical combination of hardware and software may be a general purpose computer system with a computer program that, when being loaded and executed, controls the computer system such that it carries out the methods described herein.

The present invention also may be embedded in a computer program product, which comprises all the features enabling the implementation of the methods described herein, and which when loaded in a computer system is able to earn out these methods. Computer program in the present context means any expression, in any language, code or notation, of a set of instructions intended to cause a system having an information processing capability to perform a particular function either directly or after either or both of the following: a) conversion to another language, code or notation: b) reproduction in a different material form.

This invention may be embodied in other forms without departing from the spirit or essential attributes thereof. Accordingly, reference should be made to the following claims, rather than foregoing the specification, as indicating the scope of the invention.

What is claimed is:

1. A method for presenting missed telecommunication calls within a telephony device comprising:
logging a set of missed communication attempts directed to a telephony device;
determining an image that is associated with each of the missed communication attempts, said determined images each representing a caller; and
visually presenting a set of interface items representing said missed communication attempts within a display along, wherein said set of presented interlace items comprises said determined associated images, which are displayed in the display.

2. The method of claim 1, wherein the telephony device is a mobile communication device, and wherein the display is a display of the mobile communication device.

3. The method of claim 1, wherein each of the missed communication attempts is a missed telephony call, and wherein each displayed image includes a picture of the caller.

4. The method of claim 3, wherein an entry of a local contact data store associates a set of phone numbers with a set of images, wherein said determining step compares a phone number of each missed telephony call against an entry of the local contact data store to determine the image.

5. The method of claim 3, wherein the visually presented set of missed communication attempts does not show the phone number associated with the missed call unless a user performs an action using an interlace of the telephony device, where the action results in the phone number associated with the missed call being visually displayed.

6. The method of claim 3, wherein during at least one of the missed communication attempts, a calling device sends an image to at least one of the called device and a communication infrastructure server that provides telephony services for the telephony device, wherein said determined image associated with the missed communication attempt involving the calling device is the sent image.

7. The method of claim 1, wherein said set of missed communication attempts comprises a plurality of attempts from a single communication device, said method further comprising:
grouping said plurality of attempts together as a single missed element, using a single item and a single associated image during the visually presenting step for the single missed element.

8. The method of claim 7, further comprising:
presenting a visual indicator with the single item that indicates a quantify of missed communication attempts for the single item.

9. The method of claim 1, wherein the visually presenting step presents a slideshow of the determined associated images.

10. The method of claim 1, wherein said steps of claim 1 are performed by at least one machine in accordance with at least one computer program stored in a computer readable media, said computer programming having a plurality of code sections that are executable by the at least one machine.

11. A mobile phone comprising:
a telephony interface for conducting mobile telephony communications;
a display for visually interacting with the mobile phone; and
a missed call interlace configured to present a plurality of missed call images in the display, wherein each missed call image is associated with at least one missed call and wherein each missed call image represents a caller.

12. The mobile phone of claim 11, wherein each of the missed call images comprises a picture of the caller, which when selected within the missed call interface presents information concerning the associated missed call.

13. The mobile phone of claim 11, further comprising:
a data store containing a plurality of contact entries, wherein at least a portion of the contract entries associate a phone number with an image stored within the data store, wherein at least a portion of said plurality of missed call images comprise the stored image associated with a phone number of a missed call.

14. The mobile phone of claim 12, wherein at least a portion of said plurality of missed call images comprise an image sent by a calling device as part of an attempt that resulted in a missed call.

15. The mobile phone of claim 12, further comprising:
a voice mail interface configured to present plurality of voice mail images in the display, each voice mail image being associated with at least one voice mail entry, wherein a common set of images, each associated with a phone number, are used by the voice mail interface and the missed call interface.

16. The mobile phone of claim 11, wherein the missed call interface presents the plurality of call images within a slideshow of images.

17. The mobile phone of call 11, a set of missed calls from a single source are grouped together in the missed call interface so that a single missed call image is presented for the set of missed calls.

18. The mobile phone of claim 17, wherein the missed call interface presents the plurality of call images within a slideshow of images, wherein a set of missed calls from a single source are grouped together in the missed call interface so that a single missed call image is presented for the set of missed calls, and where a duration that the single missed call image associated with the set of missed calls is shown within the slideshow is greater than a duration that a different one of the missed call images is shown, where the different one is associated with a single missed call.

19. A missed call interface comprising:
a graphical user interface of a mobile telephony device configured to visually display a set of missed calls, wherein an image representing a caller whose call was missed is presented within the graphical user interface for each of the missed calls.

20. The missed call interface of claim 19, wherein at least a portion of said presented images are retrieved from a local data store of the mobile telephony device, wherein said local data store contains a plurality of contact entries, wherein at least a portion of the contract entries associate a phone number with an image stored within the data store, wherein the mobile telephony device uses the contact entries to find an image to be displayed within the missed call interface based upon a phone number of the missed call.
